(19) United States
(12) Patent Application Publication
(10) Pub. No.: US 2025/0044262 A1
(43) Pub. Date: Feb. 6, 2025

(54) LIQUID CHROMATOGRAPH DETECTOR

(71) Applicant: SHIMADZU CORPORATION, Kyoto (JP)

(72) Inventor: Masato WATANABE, Kyoto (JP)

(73) Assignee: SHIMADZU CORPORATION, Kyoto (JP)

(21) Appl. No.: 18/784,777

(22) Filed: Jul. 25, 2024

(30) Foreign Application Priority Data
Aug. 4, 2023 (JP) 2023-127715

(51) Int. Cl. G01N 30/66; G01N 30/02; G01N 30/30; G01N 30/62

(52) U.S. Cl. CPC G01N 30/66; G01N 30/30; G01N 2030/027; G01N 2030/626

(57) ABSTRACT

A lamp house (6), a lamp (8) including a light emitting part (16) that emits light and a base end portion (18) from which a lead wire from the light emitting part (16) is drawn out, the lamp (8) being attached to the lamp house (6) in a state where the light emitting part (16) is accommodated in the lamp house (6) and the base end portion (18) is exposed to the outside of the lamp house (6), a housing (2) having an internal space and a ventilation port (24, 32) for taking air into the internal space from outside of the internal space and exhausting the air from the internal space, and accommodating the lamp house (6) in the internal space in a manner that the lamp house (6) and the base end portion (18) of the lamp (8) are located on a flow path of the air flowing through the internal space, a fan (12, 12′) provided so as to form a flow of the air in the internal space of the housing (2), and a heater (10, 10′) for heating the air taken into the internal space of the housing (2) are included. The base end portion (18) of the lamp (8) and the lead wire (20) are heated by receiving the air heated by the heater (10, 10′).

### BACKGROUND OF THE INVENTION

### 1. Field of the Invention

The present invention relates to a liquid chromatograph detector such as an absorbance detector.

### 2. Description of the Related Art

An absorbance detector, which is a liquid chromatograph detector, irradiates a cell, through which a sample flows, with light emitted from a lamp, and measures intensity of light having a specific wavelength transmitted through the cell, so as to detect and quantify a component contained in the sample flowing through the cell. It is known that light emission intensity of a lamp has temperature dependency. When temperature of a lamp fluctuates under influence of environmental temperature, intensity of light applied to a cell fluctuates, a baseline of a detector signal fluctuates, and an accurate analysis result cannot be obtained. For this reason, in general, a heater and a temperature sensor are attached to a lamp house accommodating a lamp so that temperature of the lamp is not affected by a fluctuation in environmental temperature, and temperature of the lamp house is controlled to be constant (see Patent Document 1).

A lamp of a liquid chromatograph detector has a light emitting part that emits light and a base end portion from which a lead wire from the light emitting part is drawn out. The lamp is a consumable that deteriorates with elapse of use time, and needs to be replaced as deterioration progresses. For this reason, in order to facilitate replacement work of the lamp, a structure in which the lamp is fixed to a lamp house in a state where the light emitting part is inserted into the lamp house from the outside of the lamp house is sometimes employed (see Patent Document 2).

### PRIOR ART DOCUMENTS

### Patent Documents

Patent Document 1: WO 2019/016846 A
Patent Document 2: JP 4269997 B2

### SUMMARY OF THE INVENTION

In the detector having the structure in which replacement work of a lamp is easy as described above, it has been found that, when temperature of a lamp house is controlled by attaching a heater and a temperature sensor to the lamp house, a phenomenon that a baseline of a detector signal fluctuates before a temperature fluctuation of the lamp house is detected by the temperature sensor when environmental temperature rapidly changes may occur.

The present invention has been made in view of the above problem, and an object of the present invention is to suppress a fluctuation of a baseline of a detector signal due to a fluctuation of environmental temperature while employing a structure in which replacement work of a lamp is easy.

In the structure in which replacement work of a lamp is easy as described above, a base end portion of the lamp is exposed to the outside of a lamp house, and if temperature of the lamp house is controlled to be constant, temperature of the base end portion of the lamp or a lead wire is likely to fluctuate. The inventor of the present invention has found, through an investigation, that a fluctuation in a baseline of a detector signal due to a fluctuation in environmental temperature despite temperature control of a lamp house is caused by the fact that a fluctuation in temperature of a base end portion of a lamp is caused by outside air taken into a housing passing through the base end portion of the lamp at the same temperature. The present invention has been made based on such a finding.

That is, a liquid chromatograph detector according to the present invention includes a lamp house, a lamp including a light emitting part that emits light and a base end portion from which a lead wire from the light emitting part is drawn out, the lamp being attached to the lamp house in a state where the light emitting part is accommodated in the lamp house and the base end portion is exposed to an outside of the lamp house, a housing having an internal space and ventilation ports for taking air from outside of the internal space into the internal space and exhausting the air from the internal space, and accommodating the lamp house in the internal space in a manner that the lamp house and the base end portion of the lamp are located on a flow path of the air flowing through the internal space, a fan provided so as to form a flow of the air in the internal space of the housing; and a heater for heating the air taken into the internal space of the housing. The base end portion of the lamp and the lead wire are heated by receiving the air heated by the heater.

According to the liquid chromatograph detector of the present invention, the base end portion of the lamp exposed to the outside of the lamp house is arranged on a flow path of air flowing through the internal space of the housing, and the base end portion of the lamp and the lead wire are heated by receiving the air heated by the heater. Therefore, outside air taken into the housing does not pass through the base end portion of the lamp at the same temperature, and temperature of the base end portion of the lamp is less likely to be affected by a change in environmental temperature. As a result, it is possible to suppress a fluctuation of a baseline of a detector signal due to a fluctuation of environmental temperature while employing a structure in which replacement work of the lamp is easy.

### BRIEF DESCRIPTION OF THE DRAWINGS

FIG. 1 is a schematic internal configuration diagram illustrating an embodiment of a liquid chromatograph detector;

FIG. 2 is a diagram for describing a structure of a lamp;

FIG. 3 is a schematic configuration diagram illustrating a control system of the embodiment; and

FIG. 4 is a schematic internal configuration diagram illustrating another embodiment of the liquid chromatograph detector.

### DETAILED DESCRIPTION OF THE INVENTION

Hereinafter, an embodiment of a liquid chromatograph detector according to the present invention will be described with reference to the drawings.

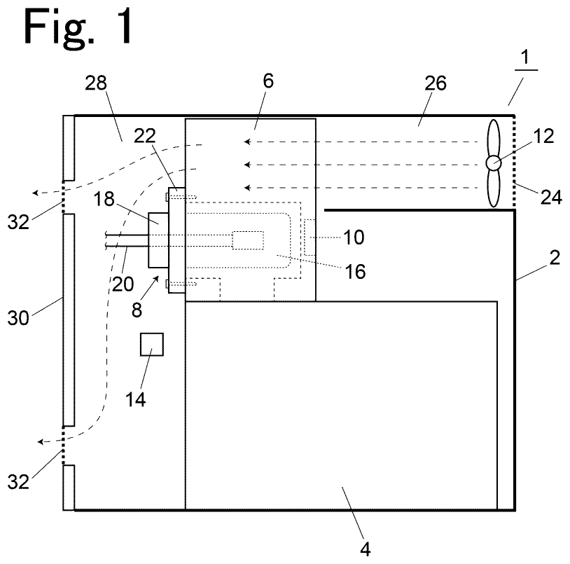

FIG. 1 illustrates an embodiment of the liquid chromatograph detector (hereinafter, the detector).

A detector 1 includes a housing 2, a spectroscope 4, a lamp house 6, a lamp 8, a heater 10, a fan 12, and a temperature sensor 14. The spectroscope 4, the lamp house 6, the lamp 8, the heater 10, the fan 12, and the temperature sensor 14 are accommodated in an internal space of the housing 2.

In FIG. 1, the left side of the housing 2 is a front surface, and the right side is a back surface. An openable and closable front panel 30 is provided on a front surface of the housing 2, and a ventilation port 32 is provided in an upper portion and a lower portion of the front panel 30. A ventilation port 24 is provided in an upper portion of a back surface of the housing 2.

A flow cell, a light receiving element, and the like are provided inside the spectroscope 4 (not illustrated). The lamp house 6 is arranged above the spectroscope 4. The lamp house 6 is a metal member, provided with a cavity for accommodating a light emitting part 16 of the lamp 8 in a lower portion, and has a fin structure in an upper portion. Light emitted from the light emitting part 16 of the lamp 8 attached to the lamp house 6 is taken into the spectroscope 4 and guided to the flow cell, and light transmitted through the flow cell or light emitted from a sample in the flow cell is guided to the light receiving element.

Here, a structure of the lamp 8 will be described with reference to FIG. 2. The lamp 8 has a structure in which an electrode part 17 is accommodated inside a glass tube 15, and a lead wire 20 for achieving electrical conduction with the electrode part 17 is drawn out from a base end (left end in the diagram) of the glass tube 15. A flange portion 22 is provided on the base end side of the glass tube 15. A portion further on the tip side (right side in the diagram) than the flange portion 22 is the light emitting part 16. A portion further on the base end side (left side in the diagram) than the flange portion 22 is referred to as a base end portion 18. The electrode part 17 is accommodated in the light emitting part 16, and the light emitting part 16 emits light as current is applied to the electrode part 17 through the lead wire 20.

Returning to FIG. 1, the flange portion 22 of the lamp 8 is screwed to an outer surface of the lamp house 6 facing the front panel 30 side of the housing 2, the light emitting part 16 is accommodated inside the lamp house 6, and the base end portion 16 is exposed to the outside of the lamp house 6 in a state of facing the front panel 30 side of the housing 2. With such a structure, opening the front panel 30 of the housing 2 and attaching and detaching the lamp 8 to and from the lamp house 6, that is, replacement work of the lamp 8 is easy.

The heater 10 is attached to the lamp house 6 to heat the lamp house 6. The fan 12 is provided on the back side in the housing 2 so as to take in outside air from the ventilation port 24 and send the outside air to the front side. Air sent to the front panel 30 side by the fan 12 passes through a duct 26, passes through a fin structure in an upper portion of the lamp house 6, passes through a space 28 on the front side in the housing 2, and is exhausted to the outside of the housing 2 from the ventilation port 32. The base end portion 18, the lead wire 20, and the flange portion 22 of the lamp 8 exist in the space 28, and air indirectly heated by the heater 10 via the lamp house 6 by passing through the lamp house 6 passes through the base end portion 18, the lead wire 20, and the flange portion 22 of the lamp 8, and the base end portion 18, the lead wire 20, and the flange portion 22 of the lamp 8 are heated.

The temperature sensor 14 is provided in the vicinity of the base end portion 18, the lead wire 20, and the flange portion 22 of the lamp 8 in the space 28. The temperature sensor 14 detects temperature of air indirectly heated by the heater 10 via the lamp house 6.

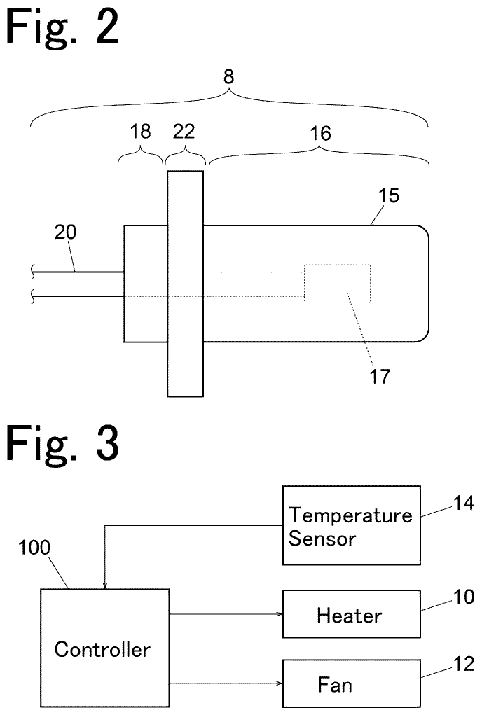

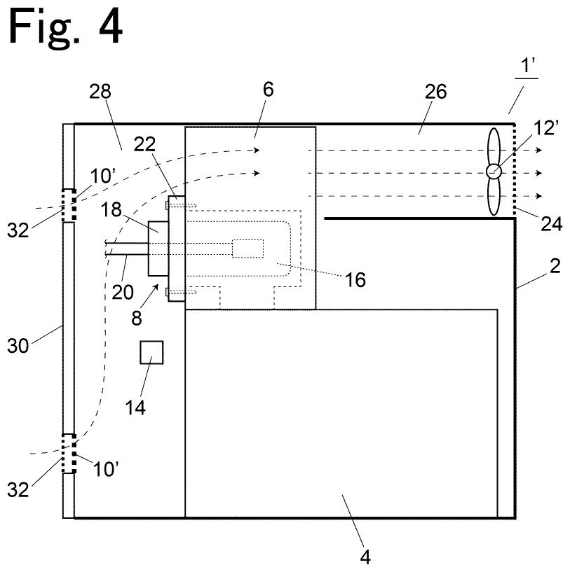

As illustrated in FIG. 3, the detector 1 includes the temperature sensor 14 and a controller 100 that controls output of the fan 12. The controller 100 controls outputs of the heater 10 and the fan 12 so that temperature detected by the temperature sensor 14 is maintained to be constant at a set temperature. Temperature detected by the temperature sensor 14, that is, temperature of air passing through the base end portion 18, the lead wire 20, and the flange portion 22 of the lamp 8 is maintained to be constant, so that temperature of the base end portion 18, the lead wire 20, and the flange portion 22 of the lamp 8 is maintained to be constant.

In this embodiment, output of the heater 10 and the fan 12 is not controlled based on temperature of the lamp house 6, but temperature of air indirectly heated by the heater 10 via the lamp house 6 is controlled to be constant, so that temperature of the lamp house 6 is stabilized, and as a result, temperature of the light emitting part 16 of the lamp 8 is also stabilized.

As described above, in the detector 1 of this embodiment, temperature of not only the light emitting part 16 of the lamp 8 but also the base end portion 18, the lead wire 20, and the flange portion 22 is maintained to be constant by control of output of the heater 10 and the fan 12 based on detected temperature of the temperature sensor 14. Therefore, as compared with a case where outside air taken into the housing 2 passes through the base end portion 18, the lead wire 20, and the flange portion 22 of the lamp 8 at the same temperature, light emission intensity of the light emitting part 16 is less likely to be affected by environmental temperature, and a fluctuation of a baseline of a detector signal caused by a fluctuation in environmental temperature is suppressed.

Although the ventilation port 32 is provided in the front panel 30 in the above embodiment, the ventilation port 32 may be provided at any position as long as air passing through the lamp house 6 is exhausted to the outside of the housing 2 after passing through the base end portion 18, the lead wire 20, and the flange portion 22, such as a side surface, an upper surface, and a lower surface close to the front panel 30 of the housing 2. Since the ventilation port 32 is provided at a position other than the front panel 30, air heated by passing through the lamp house 6 can be prevented from being exhausted to the front side of the housing 2.

Further, in the above embodiment, the heater 10 is attached to the lamp house 6, but the present invention is not limited to this, and the heater 10 may be attached to any position as long as the heater 10 can heat air before passing through the base end portion 18, the lead wire 20, and the flange portion 22 of the lamp 8.

FIG. 4 illustrates another embodiment of the detector.

In a detector 1′ illustrated in FIG. 4, a heater 10′ is provided in a portion of the ventilation port 32 of the front panel 30 of the housing 2, and a fan 12′ is provided so as to form, inside the housing 2, flow of air in which outside air is taken in from the ventilation port 32 and exhausted from the ventilation port 24. Air taken into the housing 2 from the ventilation port 32 is heated by the heater 10′, passes through the base end portion 18, the lead wire 20, and the flange portion 22 of the lamp 8, further passes through a fin structure in an upper portion of the lamp house 6, and is exhausted from the ventilation port 24 through the duct 26. That is, the base end portion 18, the lead wire 20, and the flange portion 22 of the lamp 8 are provided further on the downstream side than the heater 10′ on a path of air flowing inside the housing 2.

The temperature sensor 14 is provided to detect temperature of air taken into the housing 2 from the ventilation port 32 and heated by the heater 10′. The output of the heater 10′ and the fan 12′ is controlled so that detected temperature of the temperature sensor 14 becomes constant at a set temperature. With such a configuration, temperature of air passing through the base end portion 18, the lead wire 20, and the flange portion 22 of the lamp 8 and further passing through the lamp house 6 is controlled to be constant. As a result, temperature of the lamp house 6, the base end portion 18, the lead wire 20, and the flange portion 22 of the lamp 8 is maintained to be constant, and light emission intensity from the light emitting part 16 of the lamp 8 is stabilized.

The detectors 1 and 1′ described above are merely an example of an embodiment of the liquid chromatograph detector according to the present invention. The embodiment of the liquid chromatograph detector according to the present invention is as described below.

The embodiment of the liquid chromatograph detector according to the present invention includes a lamp including a light emitting part that emits light and a base end portion from which a lead wire from the light emitting part is drawn out, the lamp being attached to the lamp house in a state where the light emitting part is accommodated in the lamp house and the base end portion is exposed to an outside of the lamp house, a housing having an internal space and ventilation ports for taking air from outside of the internal space into the internal space and exhausting the air from the internal space, and accommodating the lamp house in the internal space in a manner that the lamp house and the base end portion of the lamp are located on a flow path of the air flowing through the internal space, a fan provided so as to form a flow of the air in the internal space of the housing; and a heater for heating the air taken into the internal space of the housing. The base end portion of the lamp and the lead wire are heated by receiving the air heated by the heater.

A first aspect of the embodiment further includes a temperature sensor provided at a position for detecting temperature of the air heated by the heater, and a controller configured to control output of the fan and/or the heater so that the temperature detected by the temperature sensor becomes set temperature. By the above, since temperature of air passing through the base end portion of the lamp is controlled to be constant, temperature of the base end portion of the lamp is stabilized, and light emission intensity of the lamp is stabilized.

In a second aspect of the embodiment, the heater is provided to directly heat the lamp house while being in thermal contact with the lamp house, and the base end portion and the lead wire are heated by the air having passed through the lamp house and indirectly heated by the heater via the lamp house. This second aspect can be combined with the first aspect.

In a third aspect of the embodiment, the heater is provided in vicinity of a ventilation port, which functions as an inlet port for taking into the internal space, of the ventilation ports of the housing. This third aspect can be combined with the first aspect.

In a fourth aspect of the embodiment, the base end portion of the lamp is arranged downstream of the heater in the flow path of the air flowing through the internal space.

### DESCRIPTION OF REFERENCE SIGNS

1, 1′ detector
2 housing
4 spectroscope
6 lamp house
8 light source
10, 10′ heater
12, 12′ fan
14 temperature sensor
15 glass tube
16 light emitting part
17 electrode part
18 base end portion
20 lead wire
22 flange portion
24, 32 ventilation port
26 duct
28 space
30 front panel
100 controller

What is claimed is:

1. A liquid chromatograph detector comprising:
a lamp house;
a lamp including a light emitting part that emits light and a base end portion from which a lead wire from the light emitting part is drawn out, the lamp being attached to the lamp house in a state where the light emitting part is accommodated in the lamp house and the base end portion is exposed to an outside of the lamp house;
a housing having an internal space and ventilation ports for taking air from outside of the internal space into the internal space and exhausting the air from the internal space, and accommodating the lamp house in the internal space in a manner that the lamp house and the base end portion of the lamp are located on a flow path of the air flowing through the internal space;
a fan provided so as to form a flow of the air in the internal space of the housing; and
a heater for heating the air taken into the internal space of the housing, wherein
the base end portion of the lamp and the lead wire are heated by receiving the air heated by the heater.

2. The liquid chromatograph detector according to claim 1, further comprising:
a temperature sensor provided at a position for detecting temperature of the air heated by the heater; and
a controller configured to control output of the fan and/or the heater so that the temperature detected by the temperature sensor becomes set temperature.

3. The liquid chromatograph detector according to claim 1, wherein
the heater is provided to directly heat the lamp house while being in thermal contact with the lamp house, and
the base end portion and the lead wire are heated by the air having passed through the lamp house and indirectly heated by the heater via the lamp house.

4. The liquid chromatograph detector according to claim 1, wherein the heater is provided in vicinity of a ventilation port, which functions as an inlet port for taking into the internal space, of the ventilation ports of the housing.

5. The liquid chromatograph detector according to claim 1, wherein the base end portion of the lamp is arranged downstream of the heater in the flow path of the air flowing through the internal space.

6. The liquid chromatograph detector according to claim 1, further comprising:
a temperature sensor provided at a position in the vicinity of the base end portion and the lead wire; and
a controller configured to control output of the fan and/or the heater so that the temperature detected by the temperature sensor becomes set temperature, wherein
temperature of air passing through the base end portion and the lead wire are maintained to be constant, so that temperature of the base end portion and the lead wire are maintained to be constant.
